(19) United States
(12) Patent Application Publication
(10) Pub. No.: US 2013/0246599 A1
(43) Pub. Date: Sep. 19, 2013

(54) MANAGEMENT APPARATUS, MANAGEMENT TARGET APPARATUS, AND APPARATUS INSTALLATION METHOD FOR REMOTE MANAGEMENT SYSTEM

(71) Applicant: Suntao YAN, Kanagawa (JP)

(72) Inventor: Suntao YAN, Kanagawa (JP)

(21) Appl. No.: 13/799,155

(22) Filed: Mar. 13, 2013

(30) Foreign Application Priority Data
Mar. 16, 2012 (JP) 2012-061050

(51) Int. Cl. H04L 12/24

(52) U.S. Cl. CPC H04L 41/0206
USPC 709/223

(57) ABSTRACT

A management apparatus for performing remote management on a management target apparatus, includes a storage storing installation data in which a user of an apparatus to be installed as the management target apparatus is associated with an apparatus identification ID of the management target apparatus; an inquiry processing unit determining whether the apparatus identification ID transmitted from the apparatus to be installed is stored as the installation data; an information acquisition unit requesting, when the apparatus identification ID is stored as the installation data, to acquire information of the apparatus; a registration processing unit registering, when the information of the apparatus is acquired, the apparatus as the management target apparatus; and an activation request unit requesting, when the apparatus is registered as the management target apparatus, activation of an agent function of the apparatus.

### CROSS-REFERENCE TO RELATED APPLICATIONS

The present application claims priority under 35 U.S.C §119 to Japanese Patent Application No. 2012-061050 filed on Mar. 16, 2012, the entire contents of which are hereby incorporated herein by reference.

### BACKGROUND OF THE INVENTION

1. Field of the Invention

The present invention generally relates to a management apparatus, a management target apparatus and an apparatus installation method for a remote management system that manages electronic apparatuses, such as a copier, a projector, and a digital camera, via a communication network.

2. Description of the Related Art

Conventionally, to remotely manage an electronic apparatus, such as a copier, a projector, a digital camera or the like, installed at its working site, by connecting the electronic apparatus to a communication network so that a management apparatus installed at another site may manage via the communication network, an installation operation has been performed to activate the agent function of the electronic apparatus.

For example, Japanese Patent No. 4347645 discloses an image forming apparatus including a communication unit that communicates with a mediation device, and a request processing unit (NRS) that transmits an effective response in response to a received request from the mediation device via the communication unit.

Further, an activation process is performed to activate the function of the request processing unit in response to a predetermined trigger. Further, until the activation process is performed, a wait state is maintained so that no effective response is returned in response to a received request.

Further, in the installation operation, it is necessary for the electronic apparatus (management target apparatus) to perform an inquiry process and a registration process with the management apparatus. Usually, those processes are performed based on the following procedure.

First, the management apparatus generates an installation request sheet based on an agreement with the user, and issues an installation request sheet No. in advance. Then, based on the issued installation request sheet No., the following operation is performed at the installation site of the management target apparatus.

(1) A screen for inputting the installation request sheet No. is displayed on a web screen or a panel screen of the management target apparatus. The input operation is performed, so that an inquiry request including the installation request sheet No. is transmitted to the management apparatus.
(2) The management apparatus authenticates the installation request sheet No. in the inquiry request, and transmits the authentication result to the management target apparatus.
(3) The management target apparatus checks the authentication result. When the authentication result is affirmative, the registration button is pressed. When the authentication result is negative, based on the displayed cause of the negative result, for example, the communication network environment may be adjusted, or the installation operation may be checked again. Finally, when the registration button is pressed after the authentication result becomes affirmative, the management target apparatus transmits a registration request to the management apparatus.
(4) Based on the registration request, the management apparatus associates and registers the user information described in the installation request sheet with the identification No. (ID) of the management target apparatus.

As a result, it becomes possible to set management information indicating which apparatus is being used by which user and which services are provided for each of the users. After the completion of the registration process, the management apparatus transmits the registration result to the management target apparatus.

(5) The management target apparatus checks the registration result, and completes the installation process when the registration result is affirmative.

As described above, by completing the installation process, the agent function of the management target apparatus may be activated. As a result of the activation of the agent function of the management target apparatus, the management target apparatus may perform polling to the management apparatus (to inquire whether there is a transmission request), so that the management target apparatus may respond to the request that may be transmitted from the management apparatus along with the response to the polling, and also the management target apparatus may transmit a notice (call) to the management apparatus.

### SUMMARY OF THE INVENTION

According to an aspect of the present invention, a management apparatus for performing remote management on a management target apparatus via a communication network, includes a storage storing installation data in which a user of an apparatus to be installed as the management target apparatus is associated with an apparatus identification ID of the management target apparatus; an inquiry processing unit determining whether the apparatus identification ID transmitted from the apparatus to be installed is stored as the installation data; an information acquisition unit requesting, when the apparatus identification ID is stored as the installation data, to acquire information of the apparatus, the information being necessary for installation registration; a registration processing unit registering, when the information of the apparatus is acquired, the apparatus as the management target apparatus; and an activation request unit requesting, when the apparatus is registered as the management target apparatus, activation of an agent function of the apparatus.

### BRIEF DESCRIPTION OF THE DRAWINGS

Other objects, features, and advantages of the present invention will become more apparent from the following description when read in conjunction with the accompanying drawings, in which:

FIG. 1 illustrates a schematic configuration of a remote management system according to an embodiment;

FIG. 2 schematically illustrates a configuration of a management apparatus;

FIG. 3 schematically illustrates a configuration of an image processing apparatus;

FIG. 4 is a block diagram illustrating an example software configuration of the image forming apparatus;

FIG. 5 illustrates a sequence diagram illustrating a flow from a communication permission process between the image processing apparatus as a management target apparatus and the management apparatus to an activation process of an agent function;

FIG. 6 illustrates an example installation request sheet;

FIG. 7 is a flowchart of a remote management process performed by the management apparatus; and

FIG. 8 is a flowchart of the remote management process performed by the image processing apparatus as a management target apparatus.

### DETAILED DESCRIPTION OF THE PREFERRED EMBODIMENTS

In a conventional installation process, workload is required to issue an installation request sheet No., perform an inquiry process and a registration process performed at the installation site of the management target apparatus. Also, time to required to perform communications between the management target apparatus and the management apparatus. As a result, working cost may be increased.

On the other hand, with recent progress and growth of communication network environments, the management target apparatus has included a function for communication networks. Therefore, it becomes less necessary to adjust or establish the communication network environment during the installation process. Therefore, the conventional installation process may be required to be reviewed.

The present invention is made in light of the above problem and recent communication network functions of the management target apparatuses. According to an embodiment, when the management apparatus performs remote management on the management target apparatus via a communication network, it may become possible to easily perform the installation process and registration process on the apparatus to be installed.

In the following, an embodiment of the present invention is described with reference to the drawings.

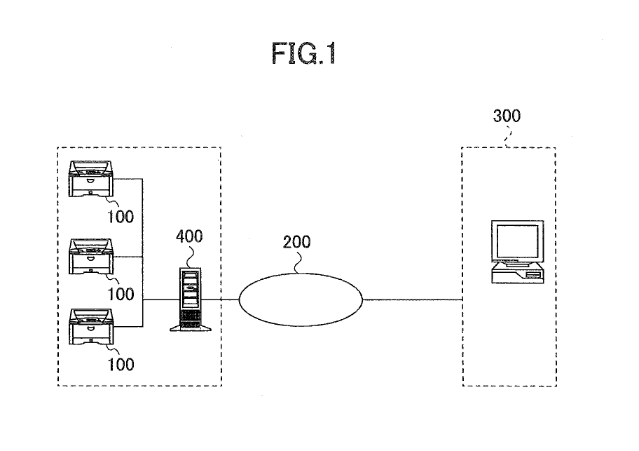

FIG. 1 schematically illustrates a remote management system according to an embodiment. Plural image processing apparatus 100, which are target apparatuses to be managed (management target apparatuses), are connected to a management apparatus 300 via a public line network 200, which is a communication network. To prevent external invasion of viruses, a firewall 400 is placed between the image processing apparatus 100 and the public line network 200.

Here, the image processing apparatus 100 and the management apparatus 300 are arranged so as to mutually transmit and receive a request and a response of a process with respect to an application software that is mutually installed in the image processing apparatus 100 and the management apparatus 300 based on the Remote Procedure Call (RPC) technique.

The RPC technique may be achieved by performing communications using a protocol such as the Point-to-Point protocol (PPP), the Transmission Control Protocol/Internet Protocol (TCP/IP), the Simple Object Access Protocol (SOAP), the Hyper Text Transfer Protocol (HTTP), or the like. Here, the image processing apparatus includes, for example, a digital copier, a projector, and a digital camera.

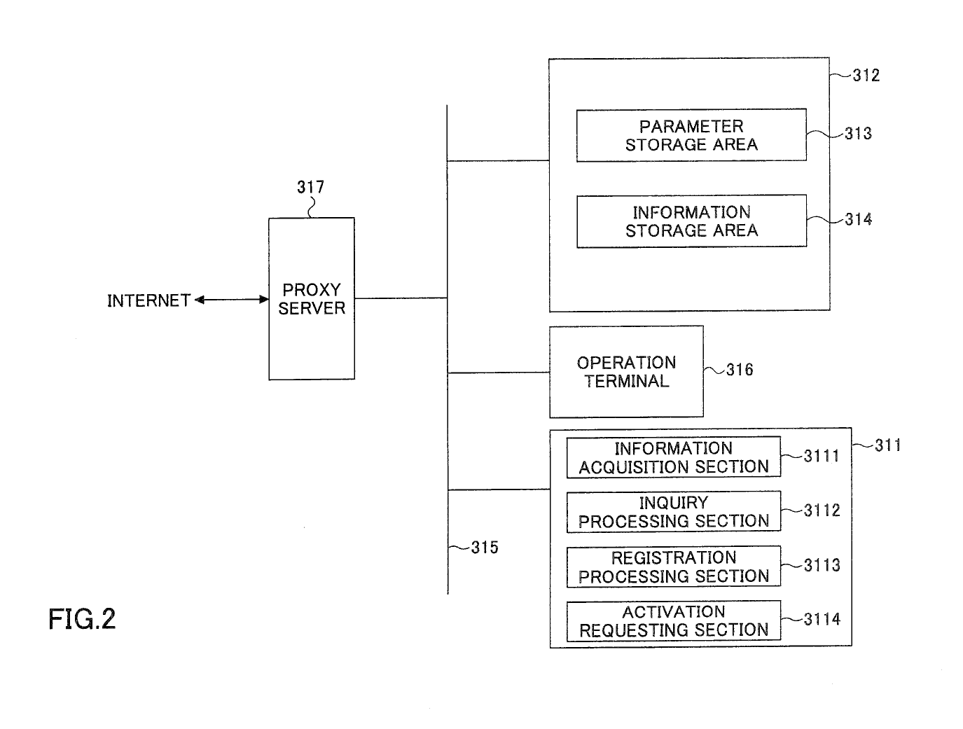

FIG. 2 schematically illustrates the management apparatus 300. The management apparatus 300 includes a controller 311, a database 312, and an operation terminal 316, which are connected via a bus 315. The management apparatus 300 is connected to the image processing apparatus 100 via a proxy server 317 and the public line network 200.

The controller 311 includes a microcomputer including a CPU, a ROM, a RAM and the like (not shown), so that the controller 311 has functions of controlling the entire management apparatus and transmitting/receiving information. More specifically, the controller 311 includes an information acquisition section 3111, an inquiry processing section 3112, a registration processing section 3113, and an activation requesting section 3114.

The information acquisition section 3111 acquires information of the image processing apparatus 100. The inquiry processing section 3112 inquires whether the apparatus identification ID transmitted from the image processing apparatus 100 is stored as the installation data described in the installation request sheet which is described below. The registration processing section 3113 registers the image processing apparatus as the management target apparatus. The activation requesting section 3114 sends a request to activate the agent function of the image processing apparatus 100.

The database 312 includes a parameter storage area 313 and an information storage area 314. The parameter storage area 313 stores various parameters, a management program, and input data of the operation terminal, that are used for management of the image processing apparatus 100 which is the management target apparatus.

The image processing apparatus 100 stores the information of the image processing apparatus 100. Further, in the database 312, the installation data, which are related to the items described in the installation request sheet, are associated and stored with user information and the apparatus identification ID.

The operation terminal 316 has a function as an input interface to input various data by an operator. Specifically, the operation terminal 316 serves as a communication setting section that sets communication permission of the agent function of the image processing apparatus 100.

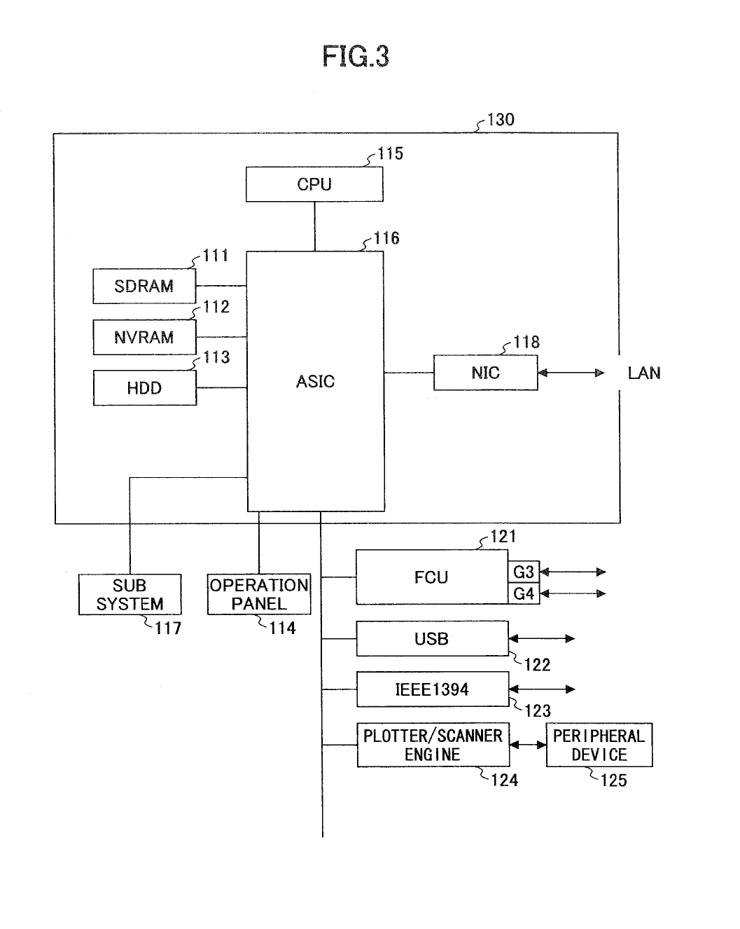

FIG. 3 schematically illustrates a configuration of the image processing apparatus 100. The image processing apparatus 100 includes a controller board 130, an operation panel 114, a Facsimile Control Unit (FCU) 121, a Universal Serial Bus (USB) 122, an IEEE1394 device 123, a plotter/scanner engine 124, and a peripheral device 125.

The controller board 130 includes a main Central Processing Unit (CPU) 115, an Application Specific Integrated Circuit (ASIC) 116, a Synchronous Dynamic Random Access Memory (SDRAM) 111, a Non-Volatile Random Access Memory (NVRAM) 112, a Hard Disk Drive (HDD) 113, and a Network Interface Card (NIC) 118.

The ASIC 116 is connected to the operation panel 114. The ASIC 116 is connected to the FCU 121, the USB 122, the IEEE1394 device 123, the plotter/scanner engine 124, and the peripheral device 125 via an internal bus. Further, the ASIC 116 is equipped with the a sub system 117 (including a sub CPU, an interface ASIC, a RAM, a ROM, a memory for remote management system, a power control circuit, and a PCI port).

The main CPU 115 performs data arithmetic processing, and control the entire apparatus. The ASIC 116 realizes sharing devices which become control targets of the main CPU 115. The SDRAM 111 is used as a memory storing various programs, and a memory to be used by the main CPU 115 in data processing.

The NVRAM 112 is used as a memory storing a boot program and an OS image, and a memory storing various data (e.g., a model number, a board number, and an IP address). The HDD 113 is a non-volatile storage medium storing a firmware for update, a firmware for execution, and a remote management program. The operation panel 114 is an interface for an operator to use to operate the image processing apparatus 100, so that the operator may input data, execute a job, display data and the like.

The NIC 118 is an interface to connect to the proxy server 317 of the management apparatus 300. The FCU 121 communicates with an external apparatus such as a FAX machine or a copier having a modem function, and control the external apparatus.

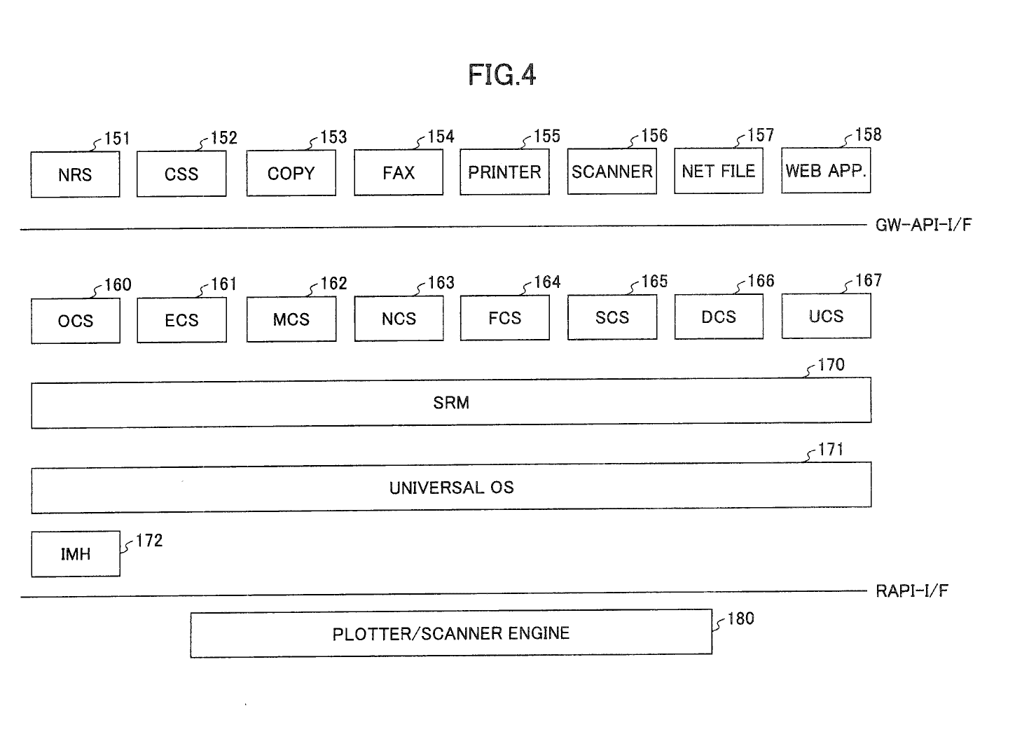

FIG. 4 is a block diagram illustrating an example software configuration of the image processing apparatus 100. The software configuration of the image processing apparatus 100 is comprised of an application module layer, a service module layer, and a universal OS layer.

A boot program stored in the NVRAM 112 on the controller board 130 is started up by the main CPU 115. Further, the OS image is read and loaded to the SDRAM 111 so as to be developed to an OS to start up the OS. The programs constituting the software are read, when necessary, so as to be developed to the SDRAM 111 and executed by the main CPU 115. Then, the main CPU 115 executes those programs on a necessity basis. By doing this, the functions according to an embodiment may be realized.

The software on the application module layer is comprised of programs that cause the main CPU 115 to function as plural application control units (process execution units) that operates hardware resources to realize predetermined functions.

The software on the service module layer is comprised of programs that cause the main CPU 115 to be disposed between the hardware resources and the application control units and to function as a service control unit (process execution unit) to receive an operation request from the plural application control units to the hardware resources, mediate the operation request, and perform execution control of the operation based on the operation request.

On the application module layer, there are an NRS application 151, a CSS application 152, a copy application 153, a fax application 154, a printer application 155, a scanner application 156, a net file application 157, and a web application 158.

On the service module layer, an Operation Control Service (OCS) 160, an Engine Control Service (ECS) 161, a Memory Control Service (MCS) 162, a Network Control Service (NCS) 163, a Fax Control Service (FCS) 164, a System Control Service (SCS) 165, a Delivery Control Service (DCS) 166, a User Control Service (UCS) 167, a System Resource Manager (SRM) 170, and an Image Memory Handler (IMH) 172. Further, on the universal OS layer, there is a universal OS 171.

The NRS application 151 and the CSS application 152 form a collective module having a function of remote management (i.e., a function of communicating with the management apparatus 300) based on different methods from each other.

The NRS application 151 includes functions of remote management using a network, the functions including converting data when data are transmitted and received via the network, and a scheduler function. The NRS application 151 further includes functions such as reporting a state information of the image processing apparatus, counter information, and firmware version information to the management apparatus, and transmitting a request to update firmware, execute a command and the like by the method. Further, the NRS application 151 further includes functions to periodically, instantly, or irregularly issue an abnormal alarm, a supply report, and a start-up report to the management apparatus.

The copy application 153 is an application program to realize a copy service. The fax application 154 is an application program to realize a fax service. The printer application 155 is an application program to realize a printer service. The scanner application 156 is an application program to realize a fax service. The net file is an application program to realize a net file service. The web application 158 is an application program to realize a web service.

The OCS 160 is a module to control the operation panel 114. The ECS 161 is a module to control an engine unit such as hardware resources. The MCS 162 is a module for memory control that, for example, acquires and releases an image memory, uses the HDD 113 and the like. The NCS 163 is a module for mediating between the network and the application programs on the application module layer.

The FCS 164 is a module to realize facsimiles functions including facsimile transmission/receiving, reading facsimile, and printing of received facsimiles. The SCS 165 is a module to perform start-up management and ending management of the application programs on the application module layer based on command contents. The DCS 166 is a module to transmit and receive an image file stored in the HDD 113 and controller board 130 by using the Simple Mail Transfer Protocol (SMTP) or a File Transfer Protocol (FTP).

The UCS 167 is a module to manage the user information including address information and mailing information registered by apparatus users. The SRM 170 is a module to control the system and manage resources. The IMH 172 is a module to manage a memory that temporarily stores image data.

The universal OS 171 is an Operating System such as UNIX (Registered Trademark), Linux(Registered Trademark), Windows(Registered Trademark) or the like.

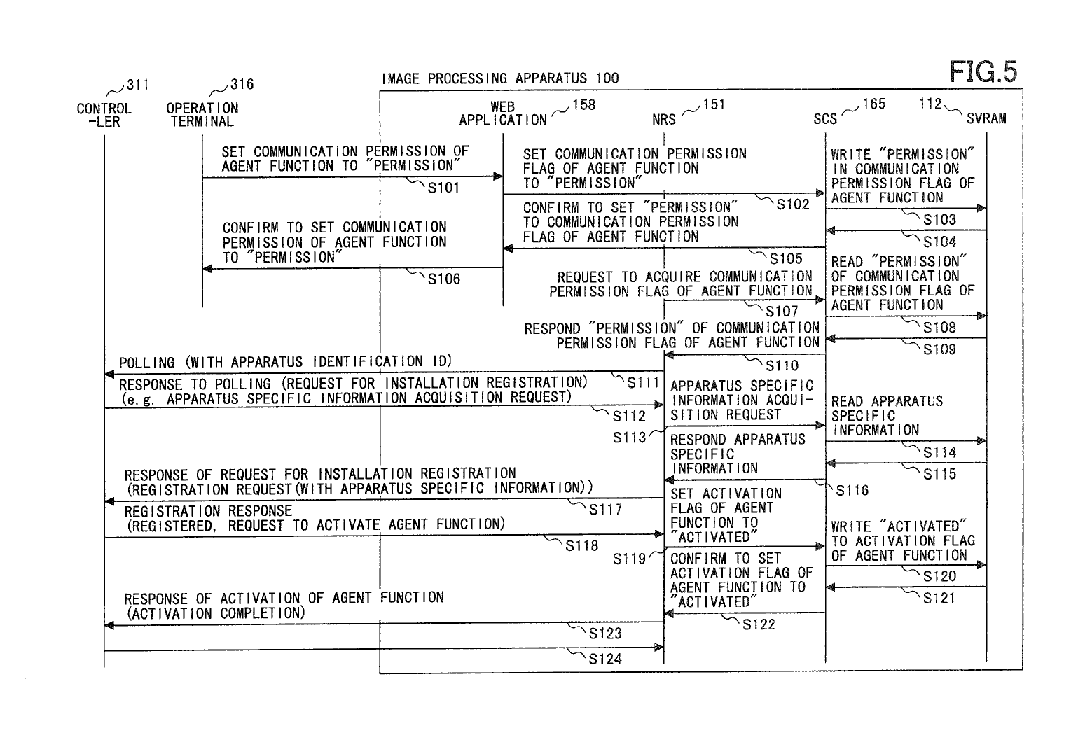

FIG. 5 is a sequence diagram illustrating processes from a communication permission process between the image processing apparatus 100 and the management apparatus 300 to an activation process to activate the agent function.

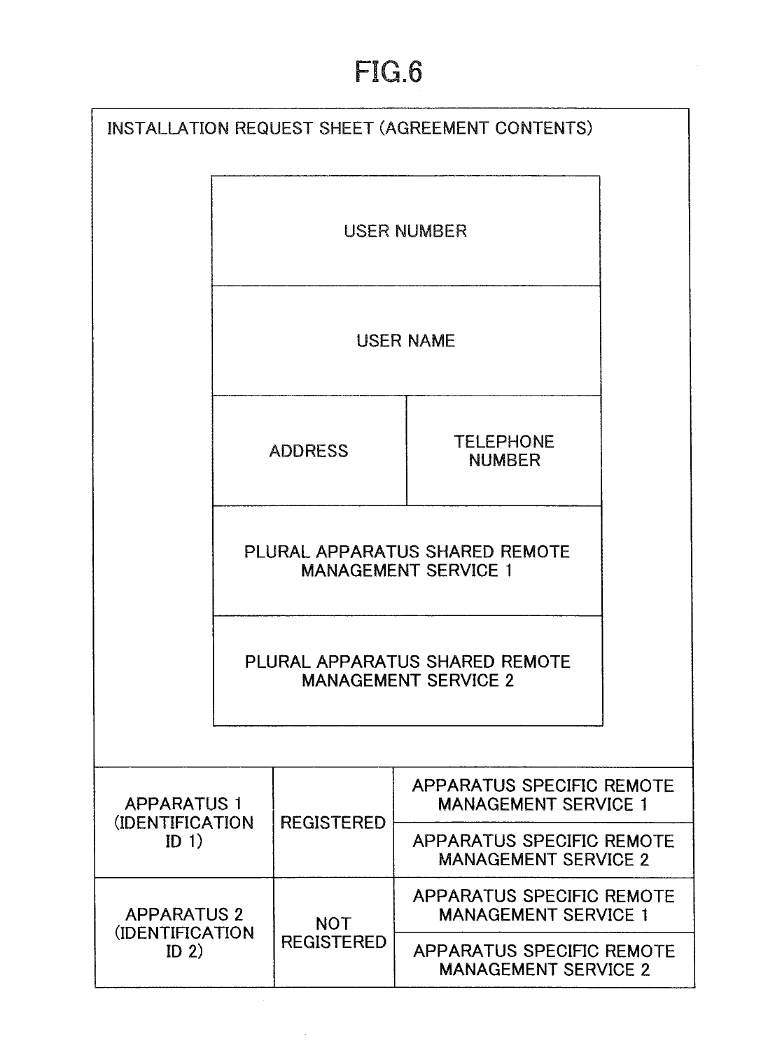

In this embodiment, it is assumed that the installation request sheet is generated (prepared) based on an agreement with a user in advance. For example, as illustrated in FIG. 6, the installation request sheet includes information items such as user information including a user number, a user name, and a user's address and telephone number, a remote management service to be used, the apparatus identification ID (management target apparatus ID) and the remote management service of the apparatus.

By inputting data of the information items of the installation request sheet as installation data into the management apparatus, the user may be associated and registered with the management target apparatus. When a new management target apparatus is added, the data of the apparatus identification ID and remote management service of the apparatus to be added may be added in the list (data) of the installation request sheet.

After the registration by inputting data of the installation request sheet via the operation terminal 316 of the management apparatus 300, a communication permission setting of the agent function is performed via the operation terminal 316.

To that end, first, on the operation terminal 316 of the management apparatus 300, “permission” is set (selected) in the communication permission setting of the agent function, so that a setting request signal requesting the communication permission to the image processing apparatus (step S101).

In the image processing apparatus, upon receiving the setting request signal requesting the communication permission by the web application 158, a web screen for the communication permission setting is displayed, so that the “permission” is set to a communication permission flag. A result that the “permission” is set to the communication permission flag is transmitted to the SCS 165 (step S102), and a writing process of writing “permission” in the communication permission flag is performed to the NVRAM 112 (step S103).

The completion of the writing process to the communication permission flag is transmitted to the SCS 165 (step S104), and is further transmitted from the SCS 165 to the web application 158 so that the web screen for the communication permission setting is displayed to confirm that the communication permission flag is set to the “permission” (step S105). The result that the communication permission flag is set to the “permission” is transmitted to the management apparatus (step S106).

In the image processing apparatus, the NRS application 151 sends a request to the SCS 165 to acquire the communication permission flag of the agent function (step S107). In response to the acquisition request, the SCS 165 performs a reading process to read the communication permission flag on the NVRAM 112 (step S108).

After performing the reading process to read the communication permission flag (step S109), the SCS 165 transmits the read communication permission flag (indicating “permission”) to the NRS application 151 (step S110).

In response to receiving the communication permission flag indicating “permission”, the NRS application 151 starts executing the polling transmission to the management apparatus 300 (step S111).

The input process on the operation terminal 316 and the web screen may be performed by setting or inputting by using, for example, an operation key to operate a panel screen of the management target apparatus, an operation button/switch on the apparatus main body (e.g., an operation button and a dip switch on a projector main body), or an operation button displayed on the projected screen.

In the polling transmission from the image processing apparatus, the apparatus identification ID is attached and transmitted. Therefore, the NRS application 151 serves as a transmission processing section to transmit the apparatus identification ID to the management apparatus 300.

In the management apparatus, upon receiving the polling, the inquiry process is performed. In the inquiry process, the transmitted apparatus identification ID is verified with the corresponding installation data described in the previously-registered installation request sheet and searched for whether there are such installation data that match the apparatus identification ID associated with the user information of the user.

When determining that the transmitted apparatus identification ID corresponds to the apparatus identification ID associated with the user information of the user, it is determined that the inquiry process result is affirmative. When there is no such apparatus identification ID, it is determined that the inquiry process result is negative. In case that the inquiry process result is affirmative, it is confirmed (determined) whether the management target apparatus has been registered already. When it is determined that the management target apparatus has been registered already, based on the registered remote management service as the target apparatus in the remote management, a request and a response from the image processing apparatus 100 are processed.

When it is determined that the management target apparatus has not been registered, a response process of responding to the polling of the management target apparatus, so that a request for the installation registration is transmitted to the image processing apparatus 100. In this example, a request to acquire specific information of the image processing apparatus 100 is transmitted to the image processing apparatus (step S112).

Here, the items of the specific information may include information items necessary for the remote management such as an identification ID, operating status information, toner remaining amount information, firmware version information, consumption (dissipation) information of maintenance parts and the like.

In the image processing apparatus, upon receiving the request for the installation registration along with the response signal to the polling, the NRS application 151 sends a request to the SCS 165 to acquire the specific information of the image processing apparatus 100 (step S113). In response to the acquisition request, the SCS 165 performs a reading process on the NVRAM 112 to read the specific information of the image processing apparatus 100 (step S114).

After the completion of the reading process to read the specific information of the image processing apparatus 100 (step S115), the SCS 165 transmits the read specific information of the image processing apparatus 100 to the NRS application 151 (step S116). In response to the transmission of the specific information of the image processing apparatus 100 from the SCS 165, the NRS application 151 sends a request to the management apparatus 300 so that the management apparatus 300 registers the image processing apparatus 100 as a target apparatus of the remote management.

In this case, the NRS application 151 attaches the specific information of the image processing apparatus 100 to the request to the image processing apparatus 100 (step S117). By doing this, the image processing apparatus 100 may serve as a registration requesting section that sends a request to the management apparatus 300 to perform the installation registration, the request including the specific information of the image processing apparatus 100. In this case, it is determined whether the agent function is activated. When it is determined that the agent function is not activated, the installation registration is requested.

In the management apparatus, upon receiving the request for the registration as the target apparatus of the remote management, the attached specific information of the image processing apparatus 100 is checked, and the installation status of the management target apparatus corresponding to the data of the installation request sheet is set to “registered”. By setting “registered”, the service on the remote management of the management target apparatus is started.

Further, a result that the registration process is completed is transmitted to the image processing apparatus 100, and a request is sent to the image processing apparatus 100 to activate the agent function (step S118). When the activation of the agent function is requested, the image processing apparatus 100 performs an activation process to activate the agent function in response to the activation request of the agent function transmitted from the management apparatus 300 if it is after the transmission of the installation registration request.

The NRS application 151 sends a request to the SCS 165 so as to set an activation flag of the agent function to “activated” (step S119). In response to the set request, the SCS 165 performs a writing process in the activation flag to the NVRAM 112 (step S120).

After the completion of the writing process of the activation flag (step S121), the SCS 165 reports that the activation flag is set to “activated” to the NRS application 151 (step S122). The NRS application 151 performs the response process to report the completion of the activation process to the management apparatus (step S123). By the activation of the agent function of the image processing apparatus 100, the management apparatus 300 starts performing a remote management process on the image processing apparatus 100 (step S124).

As a result of the activation of the agent function, it may become possible to transmit and receive data for the remote management service between the image processing apparatus 100 and the management apparatus 300. Namely, it becomes possible to perform the polling transmission (inquiring whether there is a transmission request) from the image processing apparatus 100 to the management apparatus 300.

Accordingly, it becomes possible to response to the polling along with a predetermined request from the management apparatus 300 to the image processing apparatus 100, and it becomes possible to transmit a report (call) in response to the predetermined request from the image processing apparatus 100 to the management apparatus 300.

By such an activation process, in the image processing apparatus 100, it may become possible to activate functions including a function to transmit information items including, for example, apparatus status information, counter information, firmware version information and the like to the management apparatus 300 and a function to transmit the firmware update, command execution and the like by the method.

Further, the function to periodically, instantly, or irregularly perform a report process of reporting an abnormal alarm, a supply report, and a start-up report to the management apparatus may be activated, and the remote management service by the management apparatus 300 may be started with respect to the activated functions of the image processing apparatus 100.

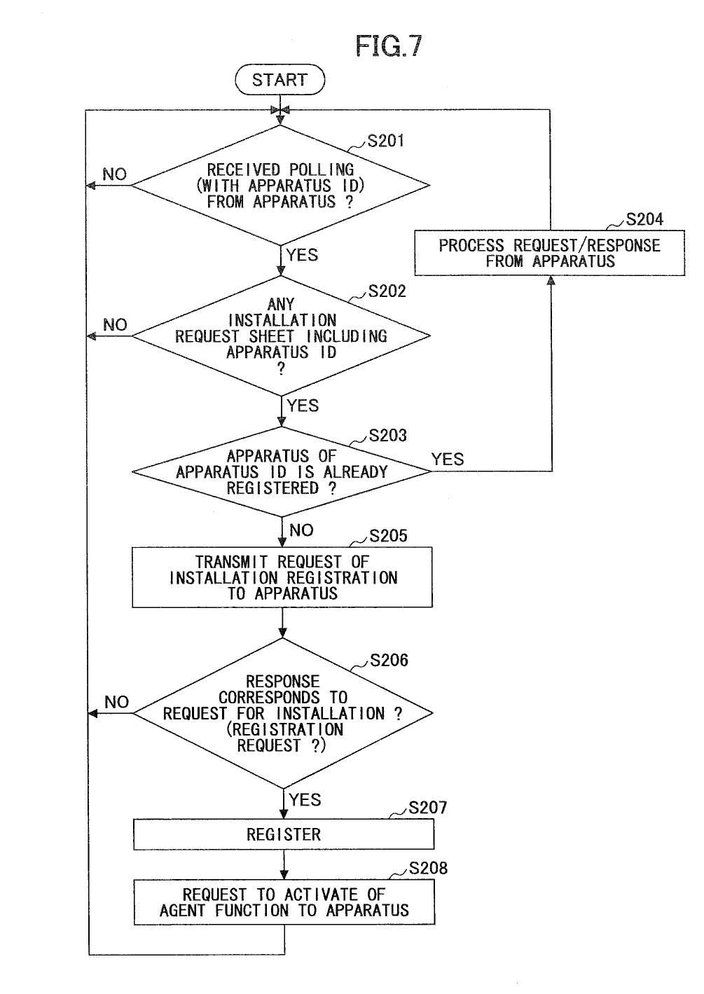

FIG. 7 is an example flowchart of the remote management process performed by the management apparatus 300. First, it is determined whether the polling with attached apparatus identification ID is received from the management target apparatus (i.e., image processing apparatus 100) (step S201). When it is determined that the polling with attached apparatus identification ID is received (YES in step S201), it is further determined whether the received apparatus identification ID matches the apparatus identification ID included in the data of the installation request sheet (step S202).

When it is determined that received apparatus identification ID matches the apparatus identification ID included in the data of the installation request sheet (YES in step S202), it is further determined whether the management target apparatus corresponding to the matched apparatus identification ID is already registered as an installation state (step S203).

When it is determined that the management target apparatus is already registered (YES in step S203), a request or a response from the management target apparatus is processed (step S204). Then the process goes back to step S201.

When it is determined that the management target apparatus is not registered (NO in step S203), a request for the installation registration is transmitted to the management target apparatus (step S205). Then, the response from the management target apparatus in response to the installation registration request is checked (step S206).

When it is determined that the response is in accordance with the installation registration request and if the registration is requested (YES in step S206), the registration process of the management target apparatus is performed (step S207), and a request for activating the agent function is transmitted to the management target apparatus (step S208). Then, the process goes back to step S201. Further, when it is determined that the received apparatus identification ID does not match any of the apparatus identification ID included in the data of the installation request sheet (NO in step S202), the process goes back to step S201.

Also, when it is determined that the response is not in accordance with the installation registration request or if the registration is not requested (NO in step S206), the process goes back to step S201. Then, the process in step S201 is repeated by determining whether the polling with the attached apparatus identification ID is received from the management target apparatus.

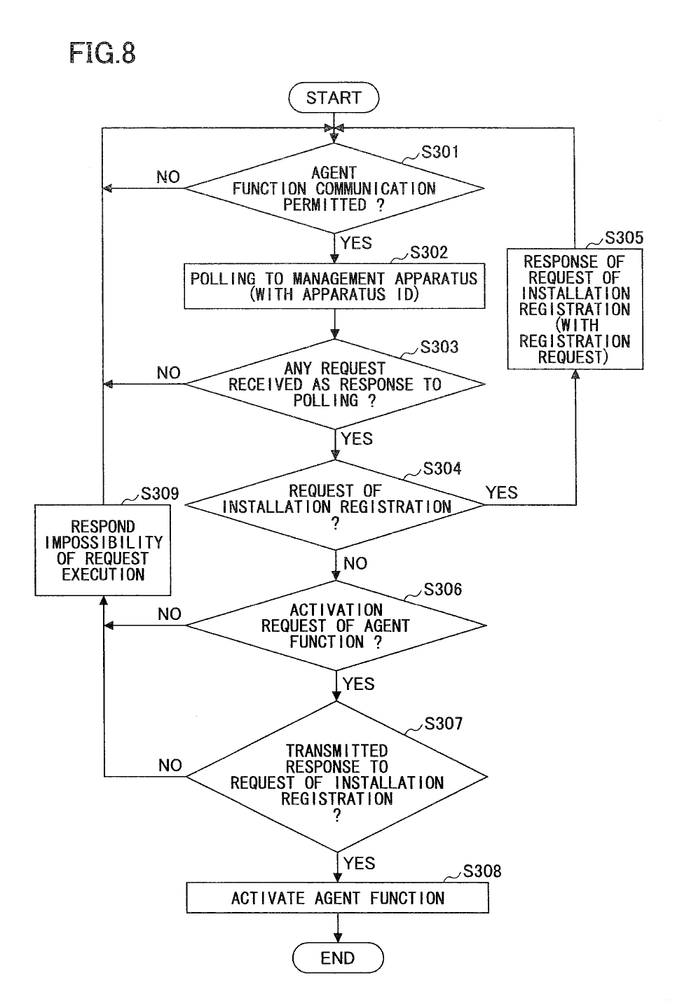

FIG. 8 is an example flowchart of a process, which is related to the remote management process, performed by the image processing apparatus 100. First, it is determined whether the communication permission flag is to be set to “permission” in response to the communication permission setting from the management apparatus 300 (step S301). When the communication permission flag is set to “permission” (YES in step S301), the polling with attached apparatus identification ID is transmitted to the management apparatus 300 (step S302).

Next, a response from the management apparatus 300 in response to the polling is received, and it is determined whether any request is included in the response (step S303). When it is determined whether a request is included (YES in step S303), it is further determined whether the request is related to the installation registration (step S304). When it is determined that the request is related to the installation registration (YES in step S304), a response in response to the request for the installation registration is performed, and as described above, the specific information of the management target apparatus is transmitted.

In this case, if the agent function is not set to “activated” (i.e., “deactivated”), a request for the registration is also performed (step S305). Then, the process goes back to step S301.

When it is determined that the request is not related to the installation registration (NO in step S304), it is determined whether the request is for the activation of the agent function (step S306). When it is determined that the request is for the activation of the agent function (YES in step S306), it is determined whether the response to the request for the installation registration is transmitted (step S307).

When it is determined that the response to the request for the installation registration is transmitted (YES in step S307), the activation process to activate the agent function is performed (step S308). When it is determined that the request is not for the activation of the agent function (NO in step S306), or when it is determined that the response to the request for the installation registration is not transmitted (NO in step S307), a response indicating that it is not possible to execute based on the request is transmitted to the management apparatus 300 (step S309).

Then, the process goes back to step S301. Further, when it is determined whether a request is not included (NO in step S303), the process goes back to step S301.

As described above, according to an embodiment, it may become possible to complete the installation operation simply by setting the communication permission setting of the agent function of the management target apparatus by a user or an installation operator without regard for a process of the installation registration between the management target apparatus and the management apparatus.

Therefore, in the installation operation of the management target apparatus such as an image processing apparatus, it may become unnecessary for an operator to perform cumbersome processes such as an inquiry process and a registration process. Therefore, a workload may be reduced.

Further, by inputting the data of the installation request sheet in the management apparatus in advance, it may become possible to associate and store the user with the management target apparatus in the management apparatus. By doing this, the installation request sheet is not necessary in an actual installation operation.

Further, after the communication permission setting of the agent function is performed, a process for the installation registration is performed between the management target apparatus and the management apparatus. During the process, information items other than the apparatus identification ID is transmitted from the management target apparatus.

Therefore, the security of the information may be enhanced. For example, the apparatus number written on a label attached to the apparatus main body is used as the apparatus identification ID, any secret information of the user may not be leaked during the installation registration process.

Further, during the installation registration, by performing encrypted communications using an electronic certificate between the management target apparatus and the management apparatus, the management apparatus may transmit encrypted request for the installation registration and the management target apparatus may decrypt the request for the installation registration and respond to the request. By doing this, security in the installation registration may be secured.

Further, after the installation registration process, the activation process to activate the agent function is performed, and the information of the management target apparatus necessary for the remote management is transmitted after the agent function is activated. Therefore, it may become possible to prevent the leakage of the information of the management target apparatus.

Further, before the activation of the agent function, the management target apparatus does not respond to the request from the management apparatus. Therefore, it may become possible to prevent the improper acquisition of the information of the management target apparatus due to management apparatus spoofing.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A management apparatus for performing remote management on a management target apparatus via a communication network, the management apparatus comprising:
a storage configured to store installation data in which a user of an apparatus to be installed as the management target apparatus is associated with an apparatus identification ID of the management target apparatus;
an inquiry processing unit configured to determine whether the apparatus identification ID transmitted from the apparatus to be installed is stored as the installation data;
an information acquisition unit configured to, when the apparatus identification ID is stored as the installation data, request to acquire information of the apparatus, the information being necessary for installation registration;
a registration processing unit configured to, when the information of the apparatus is acquired, register the apparatus as the management target apparatus; and
an activation request unit configured to, when the apparatus is registered as the management target apparatus, request activation of an agent function of the apparatus.

2. A management target apparatus that is remotely managed by a management apparatus via a communication network, the management target apparatus comprising:
a transmission processing unit configured to transmit an apparatus identification ID to the management apparatus;
a registration request unit configured to transmit information of the management target apparatus to the management apparatus and send a request to the management apparatus to perform installation registration; and
an activation processing unit configured to, after the sending of the request to perform the installation registration, activate an agent function in response to a request, transmitted from the management apparatus, to activate the agent function.

3. The management target apparatus according to claim 2,
wherein the registration request unit is configured to send the request for the installation registration when the agent function is set to deactivated.

4. A remote management system comprising:
a management apparatus according to claim 1; and
a management target apparatus according to claim 2 connected to the management apparatus via a communication network,
wherein the management apparatus is configured to perform remote management on the management target apparatus.

5. An apparatus installation method in a remote management system where a management apparatus performs remote management on a management target apparatus connected to the management apparatus via a communication network, the apparatus installation method comprising:
storing installation data in which a user of an apparatus to be installed as the management target apparatus is associated with an apparatus identification ID of the management target apparatus;
transmitting an apparatus identification ID to the management apparatus;
determining, by the management apparatus, whether the apparatus identification ID transmitted from the apparatus is stored as the installation data;
requesting when the apparatus identification ID is stored as the installation data, to acquire information of the apparatus, the information being necessary for installation registration;
transmitting information of the management target apparatus to the management apparatus and sending a request to the management apparatus to perform installation registration;
requesting, when the apparatus is registered as the management target apparatus, activation of an agent function of the apparatus; and
activating, after the sending of the request to perform the installation registration, an agent function in response to a request, transmitted from the management apparatus, to activate the agent function.
